(19) United States
(12) Patent Application Publication
(10) Pub. No.: US 2003/0235135 A1
(43) Pub. Date: Dec. 25, 2003

(54) Data reading apparatus and operating method thereof

(76) Inventors: Yin-Chun Huang, Hsinchu (TW); Chih-Wen Huang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/065,170

(22) Filed: Sep. 24, 2002

(30) Foreign Application Priority Data
Jun. 24, 2002 (TW) 91113724

(51) Int. Cl. G11B 7/00

(52) U.S. Cl. 369/102; 369/120

(57) ABSTRACT

A data reading apparatus and method of operating the data reading apparatus. The data reading apparatus is adapted to reading data stored inside an optical storage device. The data reading apparatus has a light source and an image sensor. The light source emits light and illuminates the read-out section of the optical storage device. The image sensor captures the reflected light from the read-out section of the optical storage device to form an image. The data reader may further incorporate an image processor for receiving the image from the image sensor and converting the image into digital data before outputting the data to a host. The forgoing image sensor includes a linear image semsor.

### CROSS REFERENCE TO RELATED APPLICATIONS

This application claims the priority benefit of Taiwan application serial no. 91113724, filed Jun. 24, 2002.

### BACKGROUND OF INVENTION

1. Field of Invention

The present invention relates to a data reading apparatus and its operating method. More particularly, the present invention relates to a data reading apparatus adapted to reading data from an optical storage device and a method of operating the apparatus.

2. Description of Related Art

Following an increase in demand for operating data, optical storage device such as compact disk (CD) or digital versatile disk (DVD) are developed. Due to the limited reading capacity of most data reading devices operating in a point reading mode, most large capacity optical storage devices rely on a faster rotation speed to increase data access rate. However, an increase in speed of rotation must be accompanied by a corresponding increase in positioning precision of the pick up head. Aside from positioning consideration, noise, heat and resulting instability generated by a fast-rotating disk are major factors in determining the design and cost of the optical reading device.

FIGS. 1A is a simplified side view and FIG. 1B is a simplified perspective view of a conventional data storage system. To simplify the diagrams, only hardware sections related to this invention is drawn. Other circuits or processing chips are omitted from FIGS. 1A and 1B. Since the most common optical storage devices currently in use are compact disk (CD) and digital versatile disk (DVD), the following description is based on these two types of optical storage devices.

As shown in FIG. 1A, the pick up head 110 of a conventional data reading device uses a point reading mode to access data stored inside an optical storage device 120. In other words, to read data on the optical storage device 120 spread out on different tracks, the pick up head 110 must move forward and backward in the direction indicated by the arrows. In the meantime, the optical storage device 120 has to spin around an axle 130 to bring different data sectors on a track under the pick up head 110. Because a point reading mode is used in the system, data are sequentially read. Hence, data capturing rate is dependent upon the rotation speed of the optical storage device 120 and positioning capacity of the pick up head 110.

In a conventional data reading structure, the most important factors governing the transmission of data are the positioning of the pick up head 110 (track and segment search) and the rotational speed (in revolutions per minute) of the optical storage device 120. In fact, most current data storage!systems are striving to obtain a higher rotational speed and a lower searching period.

However, any attempts to increase rotational speed or to lower search interval often needs to incorporate complicated mechanisms and stability design considerations, both adding to the design and manufacturing cost.

### SUMMARY OF THE INVENTION

Accordingly, one object of the present invention is to provide a data reading apparatus and its operation method that uses an image sensing device to serve as the pick up head. By sensing the image on an area of a storage device, a large batch of data is read from the storage device in a single reading operation. The image is analyzed using a common image reader according to brightness levels of the captured image to find the representative data values. With this arrangement, data extraction rate is increased without having to increase the rotational speed of the data storage disk.

To achieve these and other advantages and in accordance with the purpose of the invention, as embodied and broadly described herein, the invention provides a data reading apparatus for reading data from an optical storage device. The data reader includes a light source and an image sensor. The light source emits light and illuminates an area on the optical storage device where data need to be retrieved. The image sensor captures an image of this read-out portion.

In one embodiment of this invention, an image processor may be added to the data reading apparatus. The image processor receives the image captured by the image sensor and converts the image into digital signals before outputting to a host.

In a second embodiment of this invention, if the optical storage device has a circular disk profile, the image sensor preferably has a length between the radius and the diameter of the circuit disk. Alternatively, if-the optical storage device has a polygonal profile, the image sensor preferably has a length between the shortest side and the longest vertex line. In addition, the image sensor may have a size comparable to the optical storage device.

In a third embodiment of this invention, a staggered image sensor may serve as the pick up head. Alternatively, the image sensor may contain a plurality of image sensing rows.

In a fourth embodiment of this invention, the data reading apparatus may include a group of image sensors each targeting a different focal plane.

This invention also provides a method of operating a data reading apparatus. The data reading apparatus uses an image sensor to read out the data stored inside an optical storage device. The operating method includes fixing the image sensor and moving the optical storage device until the readout portion falls under the optical sensor so that the image sensor is able to pick up the data in that section. Size of the optical storage device that can be accessed by the image sensor in each sensing operation depends on the number of data points in a given area.

In an alternative embodiment according to this invention, the optical storage device is fixed in position while the image sensor moves to a desired location for capturing the data in that section. Furthermore, both the optical storage device and the image sensor may move to position the image sensor over a desired location on the optical storage device.

In brief, this invention utilizes the capacity of an image sensor for detecting data within a block of area in a single snapshot to speed up data access. In general, a larger image sensor demands a smaller rotational distance or rotational speed for the optical storage device. When the image sensor and the optical storage device have comparable dimensions, the optical storage device need not rotate at all. Thus, there is no need to increase the rotating speed of the optical storage device or to install special equipment for quieting, stabilizing or cooling the data reader. As a result, overall production cost of the entire system is reduced.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1A is a simplified side view and FIG. 1B is a simplified perspective view of a conventional data storage system;

FIG. 2 is a block diagram showing a data storage system according to one preferred embodiment of this invention;

FIGS. 3A is a simplified side view and FIG. 3B is a simplified perspective view of a data storage system according to one preferred embodiment of this invention;

FIG. 4 is a block diagram showing the data reading apparatus in area 35A of FIG. 3A according to a first preferred embodiment of this invention;

FIG. 5A is a block diagram showing the data reading apparatus in area 35A of FIG. 3A according to a second preferred embodiment of this invention;

FIG. 5B is a block diagram showing the data reading apparatus in area 35A of FIG. 3A according to a third preferred embodiment of this invention;

FIG. 6 is a simplified structural diagram showing a data storage system according to another preferred embodiment of this invention;

FIG. 7A is a simplified structural diagram showing a data storage system according to yet another preferred embodiment of this invention;

FIG. 7B is a diagram showing an image sensor with image sensing cells having different dimensions according to another preferred embodiment of this invention;

FIGS. 8A to 8C are diagrams showing the operations carried out during image reading according to this invention;

FIG. 9 is a block diagram showing an alternative architecture of a data reading system according to one preferred embodiment of this invention;

FIG. 10A is a structural diagram of a reflective optical storage device according to one preferred embodiment of this invention; and

FIG. 10B is a structural diagram of a transparent optical storage device according to one preferred embodiment of this invention.

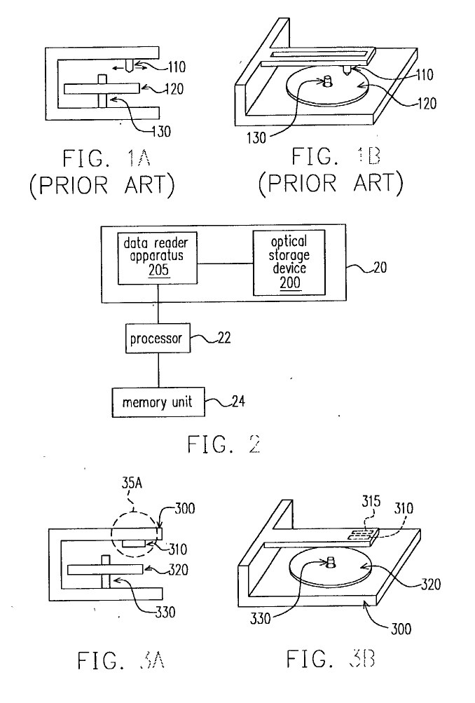

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

FIG. 2 is a block diagram showing a data storage system according to one preferred embodiment of this invention. As shown in FIG. 2, the data storage system 20 includes an optical storage device 200 and a data reading apparatus 205. The data reading apparatus 205 has a light source for illuminating the optical storage device 200 and an image sensor for detecting the image appearing on the surface of the optical storage device 200. Image data captured through the data reading apparatus 205 are transmitted to a memory unit 24 through a processor 22. The image data may be converted into digital signals inside the processor 22 by an image identification method such as OCR before transferring to the memory unit 24 for storage. Alternatively, the processor 22 only converts the analogue image data into digital data and transferred to the memory unit 24. Lastly, the image data may be directly transferred to the memory unit 24 for storage and later retrieved from the memory unit 24 for analysis only when the processor 22 is free from other activities.

The hardware structure and operating method of the data reader 205 in FIG. 2 is further explained with reference to FIGS. 3A and 3B. FIGS. 3A is a simplified side view and FIG. 3B is a simplified perspective view of a data storage system according to one preferred embodiment of this invention. The data storage system includes an outer casing 300, an image sensor 310, a light source 315, an optical storage device 320 and a spindle 330. In FIG. 3B, the image sensor 310 and the light source 315 are combined to form the data reading apparatus 205 in FIG. 2. One major aspect that differs from a conventional technique is that an image sensor 320 capable of detecting image on the surface of an optical storage device 320 is used as a pick up head. Here, the image sensor 320 can be a charge-coupled device (CCD), a contact image sensor (CIS) or a CMOS optical sensor, for example. The image sensor 320 may be selected to operate as a single linear image sensor, a multiple linear image sensor or a staggered image sensor. In addition, the image sensor 302 can be an area image sensor such as an area charge-coupled device or an area CMOS image sensor.

In FIG. 3A, the optical storage device 320 has a circular shape. Preferably, the image sensor 310 has a length between the radius and diameter of the optical storage device 320. When the image sensor 310 has a length equal to the radius of the optical storage device 320, an image of the entire surface of the optical storage device 320 is captured when the optical storage device 320 rotates once. There is no need to move the image sensor 310. On the other hand, if the image sensor 310 has a length equal to the diameter of the optical storage device 320, an image of the entire surface of the optical storage device 320 is captured when the optical storage device 320 rotates half a turn. Alternatively, through linear motion of the optical storage device 320 or the image sensor 310, image data on the entire surface of the optical storage device is captured. Either the optical storage device 320 or the image sensor 310 may be fixed in position while the other moves linearly. However, both the optical storage device 320 and the image sensor 310 may move simultaneously towards each other to save time and increase data processing speed. Consequently, compared with a conventional technique, the optical storage device in the data reading apparatus is able to provide a considerably higher data transfer rate at a relatively low rotational speed. Obviously, rotation speed of the optical storage device 320 may be further reduced through rotating the image sensor 310 in an opposite direction. For example, the optical storage device 320 may rotate in a clockwise direction while the image sensor 310 rotates in a counter-clockwise direction or vice versa. Furthermore, the optical storage device 320 may remain fix in a location while the image sensor 310 rotates over the optical storage device 320.

There are a number of advantages for the optical storage device 320 to have a low rotation speed. First and foremost is the production of less heat and noise. Moreover, a slower rotation also prevents the optical storage device 320 from vibrating too much. Hence, the image sensor 310 is able to focus onto the surface of the optical storage device 320 more readily.

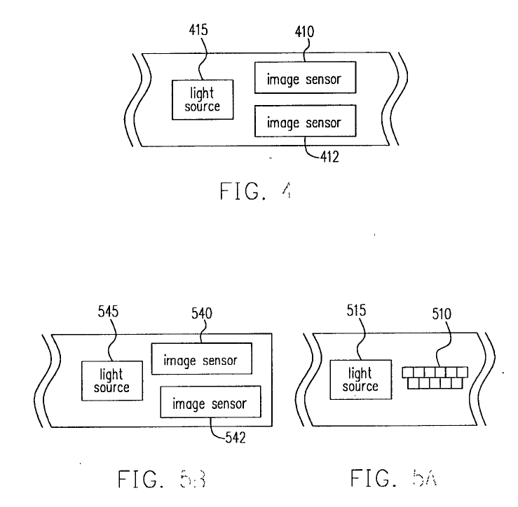

This invention also provides a method of resolving possible focusing problems in an image sensor 320. FIG. 4 is a block diagram showing the data reader in area 35A of FIG. 3A according to a first preferred embodiment of this invention. As shown in FIG. 4, the data reading apparatus includes a first image sensor 410, a second image sensor 412 and a light source 415. The first image sensor 410 and the second image sensor 412 each focuses onto a different focal plane. Obviously, both image sensors 410 and 412 may have micro-adjuster for adjusting the focus to obtain the clearest possible image for subsequent data conversion.

However, any familiar with the technologies may notice that the number of image sensors is not limited to one or two. Moreover, dimension of the image sensor is not limited to a length between the radius and diameter of an optical storage device. The number of sensors and length of each sensor may be adjusted according to design criteria. When the image sensor has a length shorter even than the radius of the optical storage device, positional movement of the image sensor must be to extend the scanning range to cover the entire optical storage device.

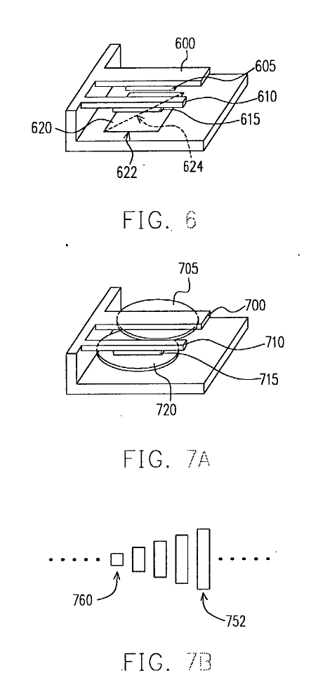

To cater for the minor shift in position when the optical storage device is installed in the data storage system, a staggered image sensor or a plurality of non-uniformly aligned linear image sensors may be deployed to cover the entire surface of the optical storage device as shown in FIGS. 5A and 5B. FIG. 5A is a block diagram showing the data reader in area 35A of FIG. 3A having a staggered image sensor 510 according to a second preferred embodiment of this invention. FIG. 5B is a block diagram showing the data reader in area 35A of FIG. 3A having a non-uniformly aligned image sensors 540 and 542 according to a third preferred embodiment of this invention.

In fact, the most effective method of covering the entire surface of the optical storage device is to use an image sensor having a size comparable to the optical storage device. When an image sensor of this size is placed over the optical storage, device, there is no need to move either the optical storage device or the image sensor to capture any data.

Although the aforementioned embodiment is mainly designed with an circular optical storage device such as compact disks or mult-function digital versatile disks in mind, the method is equally applicable to an optical storage device having other shapes. For example, the embodiment of this invention is applicable to an optical storage device having a polygonal shape. FIG. 6 is a simplified structural diagram showing a data storage system having a polygonal optical storage device according to another preferred embodiment of this invention. Unlike a previous embodiment, the image sensor 605 and the light source 615 are on separate frames 600 and 610. In other words, the light source 615 and the image sensor are not positioned next to each other. However, a hardware design with the light source 615 and the image sensor 605 adjacent to each other is equally applicable in other embodiments of this invention.

In FIG. 6, length of the image sensor 605 is roughly equal to the short edges 622 of the optical storage device 620. Under such configuration, image data on the surface of the optical storage device 620 can be obtained by moving either the optical storage device 620 or the image sensor 605 linearly. Preferably, both the optical storage device 620 and the image sensor 605 move towards each other linearly so that data can be accessed with greater speed. In general, length of an image sensor is set between the length of the shortest edge (the short edge 622 in FIG. 6) and the longest vertex line (line 624 in FIG. 6). With this arrangement, relative movement between the image sensor and the optical storage device is reduced. Ultimately, defocusing due to motion-lead vibration is minimized.

This invention also provides a data reading apparatus adapted to reduce defocusing due to vibration. FIG. 7A is a simplified structural diagram showing a data storage system according to yet another preferred embodiment of this invention. In FIG. 7A, size of the image sensor 705 hanging on the frame 700 is roughly equal to the size of the optical storage device 720. Light from the light source 715 travels to a collimating panel 710 and then illuminates the surface of the optical storage device 720. Hence, there is no need to move or rotate either the image sensor 705 or the optical storage device 720. Image data are captured simply through switching both the light source 715 and the image sensor 705 on.

At present, most optical storage device such as compact disk or multifunctional digital disk has a circular shape. Since the outer dimension of each disk is larger than the inner dimension, the image sensor 75 may have a configuration as shown in FIG. 7B. FIG. 7B is a diagram showing an image sensor with image sensing cells having different dimensions according to another preferred embodiment of this invention. As shown in FIG. 7B, image cells 752 close to the inner area of the disk is much larger than image cells 760 near the outer area of the disk. In other words, size of the cell should reflect the design configuration of each optical storage device.

In brief, the data reading apparatus of this invention operates according the following scheme:

1. Among the image sensor, the light source and the optical storage device, one them is fixed in position while the other two moves or rotates in such a way that the image sensor is able to capture image on the optical storage device. For example, if the image sensor covers a sufficiently large area and the image sensor is fixed while the light source and the optical storage device is able to move linearly or rotate in the same direction, a clear surface image is obtained with relatively little movement. On the contrary, if the light source and the optical storage device move linearly or rotate in opposite direction, time period to extract a surface image is shortened. Similarly, if the light source illuminates a sufficiently large area of the optical storage device and the light source is fixed while the image sensor and the optical storage device moves linearly or rotate in the same direction, a clear surface image is obtained with relatively little movement. Conversely, if the image sensor and the optical storage device move linearly or rotate in opposite direction, time period to extract a surface image is shortened.

2. Among the image sensor, the light source and the optical storage device, two of them is fixed in position while the remaining one moves or rotates in such a way that the image sensor is able to capture image on the optical storage device. For example, if the image sensor has a dimension sufficiently large (for example, roughly equal to the optical storage device), the image sensor and the optical storage device may be entirely fixed while the light source moves to obtain a surface image anywhere on the optical storage device. On the other hand, if the light source-illuminates a sufficiently large area (for example, roughly equal to the size of the optical-storage device), the light source and the optical storage device may be entirely fixed while the image sensor moves to obtain a surface image anywhere on the optical storage device.

3. The image sensor, the light source and the optical storage device are all fixed in position. However, this mode of operation is applicable only if the image sensor and the light source have size and coverage roughly equal to the size of the optical storage device.

4. Each one of the image sensor, light source and optical storage device is free to rotate or move in a linear direction.

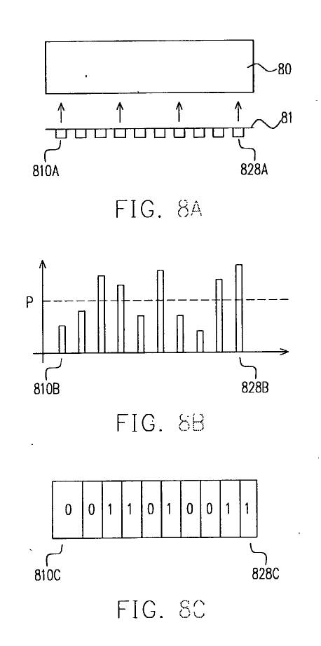

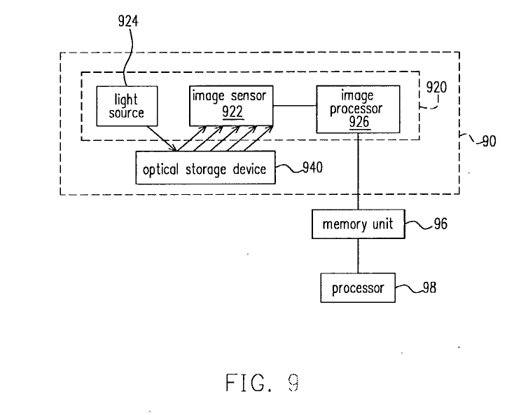

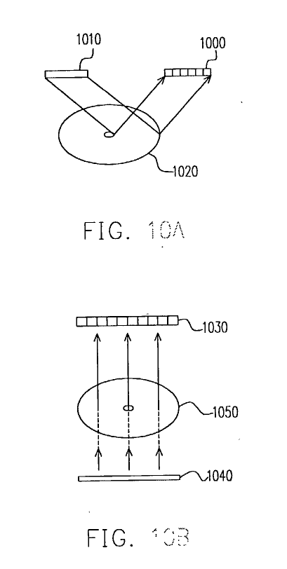

FIGS. 8A to 8C are diagrams showing various configurations during an image reading operation. In FIG. 8A, the image sensor 80 extracts an image by capturing light reflected from various data points (810A˜828A) on the surface of the optical storage device 81. The brightness level of each data point (810B˜828B) in the image is shown in FIG. 8B. If the optical storage device 81 stores data in the binary format, image identification (may be carried out using the processor 22 in FIG. 2 or using a built-in image processor 926 inside the data reading apparatus 920 as shown in FIG. 9) may be carried out using a preset level (point P in FIG. 8B) to determine the value represented by a particular image point. After such conversion, the brightness level in FIG. 8B is converted into binary values (810C˜828C) as shown in FIG. 8C.

FIG. 9 is a block diagram showing an alternative architecture of a data reading system according to another preferred embodiment of this invention. In FIG. 9, the data storage system 90 similarly has an optical storage device 940 and a data reading apparatus 920. The data reading apparatus 920 further includes an image sensor 922, a light source 924 and an image processor 926. After the image obtained from the image sensor 922 is decoded into digital data inside the image processor 926 in a manner described in FIGS. 8A to 8C, the data is directly transferred to a memory unit 96 for storage. The digital image data will remain inside the memory unit 96 until the processor 98 is free.

Although the aforementioned embodiments all depend illuminating the surface of the optical storage device with a light source and capturing the reflected light from the surface of an optical storage device, this is by no means the only design. It is also perfectly feasible to use a transparent optical storage device with an operating similar to a reflective optical storage device. In fact, only the hardware portion of the design may be different as shown in FIGS. 10A and 10B. FIG. 10A is a structural diagram of a reflective optical storage device according to one preferred embodiment of this invention and FIG. 10B is a structural diagram of a transparent optical storage device according to one preferred embodiment of this invention. In a reflective system as shown in FIG. 10A, the image sensor 1000 and the light source 1010 are on the same side of the optical storage device 1020. Light travels in the arrow direction from the light source 1010 to the surface of the optical storage device 1020 and reflects into the image sensor 1000. In a transparent system as shown in FIG. 10B, the image sensor 1030 and the light source 1040 are on the opposite side of the optical storage device 1050. Light travels in the arrow direction from the light source 1040 and passes through the optical storage device 1050 to arrive at the image sensor 1030.

In conclusion, this invention utilizes a sensor to capture an image in a portion of an optical storage device containing data points so that data can be rapidly read. Since there is no need to increase the rotating speed of the optical storage device, less heat and noise are generated by the data reading system and less equipment is needed to stabilize and cool the optical storage device. As a result, overall production cost of the data reading system is reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A data reading apparatus for reading data from an optical storage device, comprising:
a light source that emits light and illuminate a section of the optical storage device; and
a first image sensor for capturing a data image reflected from the illuminated section of the optical storage device.

2. The data reading apparatus of claim 1, wherein the first image sensor has a length intermediate between the radius and diameter of the optical storage device if the optical storage device has a circular profile.

3. The data reading apparatus of claim 1, wherein the first image sensor has a length intermediate between the shortest side and the longest vertex line if the optical storage device has a polygonal profile.

4. The data reading apparatus of claim 1, wherein the first image sensor includes a linear image sensor.

5. The data reading apparatus of claim 4, wherein the linear image sensor is selected from a group consisting of charge-coupled device, contact image sensor and a CMOS sensor.

6. The data reading apparatus of claim 4, wherein the linear image sensor includes a staggered image sensor.

7. The data reading apparatus of claim 1, wherein the first image sensor includes an area image sensor.

8. The data reading apparatus of claim 7, wherein the area image sensor is selected from a group consisting of an area charge-coupled device and an area CMOS sensor.

9. The data reading apparatus of claim 7, wherein the first image sensor has a size comparable to the optical storage device.

10. The data reading apparatus of claim 1, wherein the first image sensor includes a plurality of image-sensing rows.

11. The data reading apparatus of claim 1, wherein the apparatus further includes an image processor for receiving the image and converting the image into digital data.

12. The data reading apparatus of claim 1, wherein the plurality of sensing cells within the first image sensor has at least two different dimensions.

13. The data reading apparatus of claim 12, wherein the sensing cells in the outer region of the optical storage device has a dimension greater than the sensing cells in the inner region of the optical storage device.

14. The data reading apparatus of claim 1, wherein the apparatus further includes a second image sensor having a focal plane at a different level from the first image sensor.

15. The data reading apparatus of claim 14, wherein length of at least one of the two image sensors is intermediate between the radius and diameter of the optical storage device if the optical storage device has a circular profile.

16. The data reading apparatus of claim 14, wherein length of at least one of the two image sensors is intermediate between the shortest edge and the longest vertex line if the optical storage device has a polygonal profile.

17. The data reading apparatus of claim 14, wherein at least one of the two image sensors is a linear image sensor.

18. The data reading apparatus of claim 17, wherein the linear image sensor is selected from a group consisting of charge-coupled device, contact image sensor and CMOS sensor.

19. The data reading apparatus of claim 17, wherein the linear image sensor includes a staggered image sensor.

20. The data reading apparatus of claim 14, wherein the first image sensor includes an area image sensor.

21. The data reading apparatus of claim 20, wherein the area image sensor is selected from a group consisting of an area charge-coupled device and an area CMOS sensor.

22. The data reading apparatus of claim 14, wherein at least one of the two image sensors includes a plurality of image-sensing rows.

23. The data reading apparatus of claim 14, wherein the apparatus further includes an image processor for receiving the image and converting the image into digital data.

24. The data reading apparatus of claim 14, wherein the plurality of sensing cells within the first image sensor and the second image sensor has at least two different dimensions.

25. The data reading apparatus of claim 24, wherein the sensing cells in the inner region of the optical storage device has a dimension greater than the sensing cells in the outer region of the optical storage device.

26. The data reading apparatus of claim 1, wherein the optical storage device is selected from a group consisting of compact disk and multifunctional digital versatile disk.

27. The data reading apparatus of claim 1, wherein the light source also illuminates regions outside the reading section of the optical storage device.

28. The data reading apparatus of claim 1, wherein the light source is positioned away from any one of the image sensors.

29. The data reading apparatus of claim 1, wherein the light source is positioned close to any one of the image sensors.

30. The data reading apparatus of claim 1, wherein the image is the light obtained from the surface of the optical storage device after light emitted from the light source is reflected.

31. The data reading apparatus of claim 1, wherein the image is the light obtained after light emitted from the light source passes through the optical storage device.

32. A method of operating a data reading apparatus, wherein the data reading apparatus uses an image sensor to capture light reflected from an optical storage device when illuminated by a light source, the operating method comprising the steps of:
turning the light source on; and
operating the image sensor, the light source and the optical storage device so that the image sensor is able to capture an image from a particular a read-out section.

33. The method of claim 32, wherein the image sensor has a capturing range equal to a region containing a plurality of data points on the optical storage device.

34. The method of claim 32, wherein the step of operating the image sensor, the light source and the optical storage device includes the following sub-steps:
fixing the optical storage device; and
rotating the image sensor and the light source.

35. The method of claim 34, wherein the image sensor and the light source rotate in a clockwise direction.

36. The method of claim 34, wherein the image sensor and the light source rotate in an anti-clockwise direction.

37. The method of claim 32, wherein the step of operating the image sensor, the light source and the optical storage device includes the following sub-steps:
fixing the optical storage device; and
moving the image sensor and the light source linearly.

38. The method of claim 32, wherein the step of operating the image sensor, the light source and the optical storage device includes the following sub-steps:
fixing the light source and the image sensor; and
rotating the optical storage device.

39. The method of claim 38, wherein the optical storage device rotates in a clockwise direction.

40. The method of claim 38, wherein the optical storage device rotates in an anti-clockwise direction.

41. The method of claim 32, wherein the step of operating the image sensor, the light source and the optical storage device includes the following sub-steps:
fixing the light source and the image sensor; and
moving the optical storage device linearly.

42. The method of claim 32, wherein the step of operating the image sensor, the light source and the optical storage device includes the following sub-steps:
fixing the light source; and
rotating the image sensor and the optical storage device.

43. The method of claim 42, wherein the image sensor and the optical storage device rotate in a clockwise direction.

44. The method of claim 42, wherein the image sensor and the optical storage device rotate in an anti-clockwise direction.

45. The method of claim 42, wherein the image sensor rotates in a clockwise direction and the optical storage device rotates in an anti-clockwise direction.

46. The method of claim 42, wherein the image sensor rotates in an anti-clockwise direction and the optical storage device rotates in a clockwise direction.

47. The method of claim 32, wherein the step of operating the image sensor, the light source and the optical storage device includes the following sub-steps:
fixing the light source; and
moving the image sensor and the optical storage device linearly.

48. The method of claim 47, wherein the image sensor and the optical storage device move in the same direction.

49. The method of claim 47, wherein the image sensor and the optical storage device move in opposite direction.

50. The method of claim 32, wherein the step of operating the image sensor, the light source and the optical storage device includes the following sub-steps:
fixing the image sensor and the optical storage device; and
rotating the light source.

51. The method of claim 50, wherein the light source rotates in a clockwise direction.

52. The method of claim 50, wherein the light source rotates in an anti-clockwise direction.

53. The method of claim 32, wherein the step of operating the image sensor, the light source and the optical storage device includes the following sub-steps:
fixing the image sensor and the optical storage device; and
moving the light source linearly.

54. The method of claim 32, wherein the step of operating the image sensor, the light source and the optical storage device includes the following sub-steps:
fixing the light source and the optical storage device; and
rotating the image sensor.

55. The method of claim 54, wherein the image sensor rotates in a clockwise direction.

56. The method of claim 54, wherein the image sensor rotates in an anti-clockwise direction.

57. The method of claim 32, wherein the step of operating the image sensor, the light source and the optical storage device includes the following sub-steps:
fixing the light source and the optical storage device; and
moving the image sensor linearly.

58. The method of claim 32, wherein the step of operating the image sensor, the light source and the optical storage device includes the following sub-steps:
fixing the image sensor; and
rotating the light source and the optical storage device.

59. The method of claim 58, wherein the light source and the optical storage device rotate in a clockwise direction.

60. The method of claim 58, wherein the light source and the optical storage device rotate in an anti-clockwise direction.

61. The method of claim 58, wherein the light source rotates in a clockwise direction and the optical storage device rotates in an anti-clockwise direction.

62. The method of claim 58, wherein the light source rotates in an anti-clockwise direction and the optical storage device rotates in a clockwise direction.

63. The method of claim 32, wherein the step of operating the image sensor, the light source and the optical storage device includes the following sub-steps:
fixing the image sensor; and
moving the light source and the optical storage device linearly.

64. The method of claim 63, wherein the light source and the optical storage device moves in the same direction.

65. The method of claim 63, wherein the light source and the optical storage device moves in opposite directions.

66. The method of claim 32, wherein the step of operating the image sensor, the light source and the optical storage device includes rotating the image sensor, the light source and the optical storage device concurrently.

67. The method of claim 66, wherein the image sensor, the light source and the optical storage device rotate in a clockwise direction.

68. The method of claim 66, wherein the image sensor, the light source and the optical storage device rotate in an anti-clockwise direction.

69. The method of claim 66, wherein at least one among the image sensor, the light source and the optical storage device rotates in a clockwise direction while the remaining two rotates in an anti-clockwise direction.

70. The method of claim 66, wherein at least one among the image sensor, the light source and the optical storage device rotates in an anti-clockwise direction while the remaining two rotates in a clockwise direction.

71. The method of claim 32, wherein the step of operating the image sensor, the light source and the optical storage device includes moving the image sensor, the light source and the optical storage device linearly and concurrently.

72. The method of claim 71, wherein the image sensor, the light source and the optical storage device move in the same direction.

73. The method of claim 71, wherein any one among the image sensor, the light source and the optical storage device and the remaining two move in opposite direction.

74. The method of claim 32, wherein the step of operating the image sensor, the light source and the optical storage device includes fixing the image sensor, the light source and the optical storage device.

75. The method of claim 32, wherein light emitted from the light source passes through the optical storage device.

76. The method of claim 32, wherein the optical storage device reflects light emitted from the light source.
